(19) United States
(12) Patent Application Publication
(10) Pub. No.: US 2010/0067456 A1
(43) Pub. Date: Mar. 18, 2010

(54) Method for Establishing a Circuit Switched Call at a Dual Mode Access Terminal

(75) Inventors: Xiang Xu, Jiangsu (CN); Chuan Xu, Beijing (CN); Wei-Dong Zuo, Beijing (CN)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/375,439

(22) PCT Filed: Jul. 9, 2007
(86) PCT No.: PCT/US07/73025

§ 371 Date: Nov. 20, 2009

(30) Foreign Application Priority Data
Jul. 28, 2006 (CN) 200610108141.0

(51) Int. Cl. H04W 88/06; H04L 12/66

(52) U.S. Cl. 370/329; 370/352

(57) ABSTRACT

A method for establishing a circuit switched call at an access terminal that is processing an established packet switched call, enables a user to be informed that a voice call has been requested. The method comprises transmitting, from a visited network to the access terminal, a packet switched message indicating that the voice call has been requested (step 805). A message from the access terminal, indicating that the voice call is being processed, is then processed in the visited network (step 810). A message from the access terminal requesting a circuit switched call origination is then processed at a mobile switching center in the visited network (step 820). A message indicating that the circuit switched call should be established is then transmitted from the visited network to a voice call continuity application server in a home network, in response to the circuit switched call origination message (step 830). The circuit switched call is then connected (step 835).

### FIELD OF THE INVENTION

The present invention relates generally to dual mode access terminals that can process both packet switched and circuit switched calls. In particular, the invention relates to establishing a circuit switched call at an access terminal that is processing an established packet switched call.

### BACKGROUND OF THE INVENTION

An Internet Protocol (IP) Multimedia Subsystem (IMS) is a core network that combines IP multimedia and telephony. IMS standards have been provided by the Third Generation Partnership Project (3GPP), Third Generation Partnership Project 2 (3GPP2), and Internet Engineering Task Force (IETF) organizations and define a generic architecture for Voice over IP (VoIP) and multimedia services. In conjunction with cellular/Wi-Fi dual-mode wireless communication devices, users are able to employ IMS to obtain seamless mobility and Voice Call Continuity (VCC) between conventional circuit switched (CS) networks and packet switched (PS) networks.

Evolution of cellular communications has resulted in a proliferation of networks that use different technologies and corresponding different air interfaces. An example of a circuit radio access network (RAN) is a code division multiple access (cdma) cdma2000 1X RAN providing only circuit voice or circuit data service. Some examples of packet data network technologies employed in packet RANs include cdma2000 high rate packet data (HRPD), also known as 1XEV-DO (1X Evolution Data Only), cdma2000 1XRTT, cdma2000 1X-EV-DV (1X Evolution Data/Voice), IEEE 802.11a/b/g, and IEEE 802.16. The associated packet RANs can provide various multimedia services, such as video telephony (VT) services.

As a result, during the course of an established call in one RAN, it is often desirable to provide service notification information concerning another incoming call from another RAN. If a user accepts the new incoming service, it is then also desirable to establish a service connection in the other RAN. However, IMS standards and technologies have not provided efficient means for notifying a dual-mode device, which is currently conducting a packet-switched service in a packet RAN, that a circuit-switched service has been requested in a circuit RAN. Also, current standards and technologies have not provided efficient means for establishing a new service in a second RAN after a user decides to accept the new service. Yet such notifications and service establishment can be useful to enable device users to obtain the full benefits of IMS networks.

### SUMMARY OF THE INVENTION

According to one aspect, the present invention is a method for establishing a circuit switched call at an access terminal that is processing an established packet switched call. The method comprises transmitting, from a visited network to the access terminal, a packet switched message indicating that a voice call has been requested. A message from the access terminal, indicating that the voice call is being processed, is then processed in the visited network. A message from the access terminal requesting a circuit switched call origination is then processed at a mobile switching center in the visited network. A message indicating that the circuit switched call should be established is then transmitted from the visited network to a voice call continuity application server in a home network, in response to the message from the access terminal requesting a circuit switched call origination. The circuit switched call is then connected.

Advantages of embodiments of the present invention thus include enabling an access terminal that has dual mode capabilities, such as a dual mode cellular telephone or other wireless communication device, that is operating in a packet switched mode and processing an established packet switched call, to receive a message indicating that a voice call to the access terminal has been requested. A user is able to either accept or reject the requested voice call. If the voice call is accepted, the packet switched call is released and a circuit switched call is established.

### BRIEF DESCRIPTION OF THE DRAWINGS

In order that the invention may be readily understood and put into practical effect, reference now will be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a block diagram illustrating a wireless communication system in accordance with some embodiments of the present invention.

FIG. 2 is a block diagram illustrating an architecture of an access terminal (AT), in accordance with some embodiments of the present invention.

FIG. 3 is a block diagram illustrating an architecture of a base station (BS), in accordance with some embodiments of the present invention.

FIG. 4 is a block diagram illustrating an architecture of a mobile switching center (MSC), in accordance with some embodiments of the present invention.

FIG. 5 is a block diagram illustrating an architecture of a media gateway control function (MGCF), in accordance with some embodiments of the present invention.

FIG. 6 is a block diagram illustrating an architecture of a voice call continuity application server (VCC AS), in accordance with some embodiments of the present invention.

FIGS. 7A and 7B are a message sequence charts illustrating a method for establishing a circuit switched (CS) call at an access terminal (AT) that is processing an established packet switched (PS) call through a packet data network, according to some embodiments of the present invention.

FIG. 8 is a general flow diagram illustrating a method for establishing a circuit switched (CS) call at an access terminal (AT) that is processing an established packet switched (PS) call, according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to establishing a circuit switched call at an access terminal that is processing an established packet switched call. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as left and right, first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

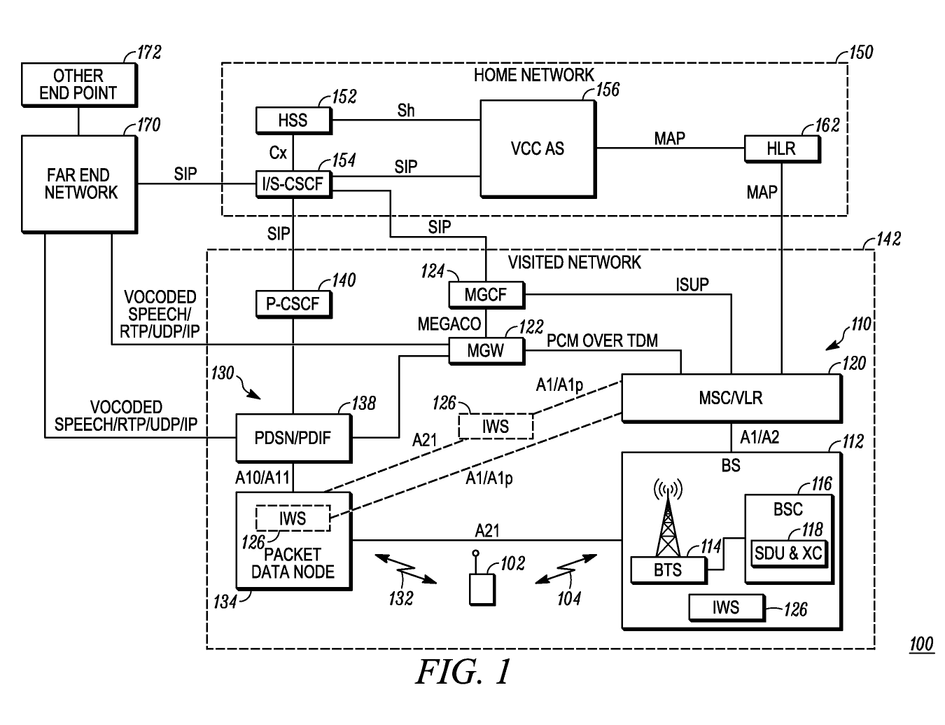

Turning now to the drawings, the present invention may be more fully described with reference to FIGS. 1-8. Referring to FIG. 1, a block diagram illustrates a wireless communication system 100, in accordance with some embodiments of the present invention. Communication system 100 includes a wireless access terminal (AT) 102, for example but not limited to a cellular telephone, a radiotelephone, or a Personal Digital Assistant (PDA), personal computer (PC), or laptop computer equipped for wireless voice communications. In various communications systems, AT 102 may also be referred to as a subscriber unit (SU), a mobile station (MS), a hybrid terminal, or a user's equipment (UE). AT 102 is capable of engaging in a packet data call with packet data network 130 and is further capable of engaging in a circuit voice or data call with circuit services network 110, and more particularly is capable of communicating with packet data node 134.

As depicted in FIG. 1, AT 102 is associated with a first, home network 150 but resides in a second, visited network 142. Visited network 142 includes both a wireless circuit services cellular communication network 110, such as a cdma2000 (Code Division Multiple Access 2000) 1X network, and a wireless packet data communication network 130 that provides VoIP services, such as a cdma2000 HRPD (High Rate Packet Data) packet data communication network 130. 1X is a spectrally efficient technology for circuit-switched voice communications, which enables applications such as multimedia messaging and GPS-based location services. Circuit services network 110 includes a Base Station (BS) 112 that comprises a Base Transceiver Station (BTS) 114 operably coupled to a Base Station Controller (BSC) 116. BS 112 is coupled to a Mobile Switching Center (MSC) 120 via both a signaling (A1) and a bearer (A2) interface. MSC 120 includes call control and mobility management functionality (not shown), such as a Visited Location Register (VLR), and switching functionality (not shown) and is coupled to a Media Gateway (MGW) 122 via a bearer interface, preferably a Pulse Code Modulation over Time Division Multiplexing (PCM over TDM) interface. Circuit services network 110 further includes a Media Gateway Control Function (MGCF) 124 that is coupled to each of MGW 122 and MSC 120 via a signaling interface, preferably to MGW 122 via a Media Gateway Control protocol (Megaco) interface and to MSC 120 via an ISDN User Part (ISUP) interface.

BSC 116 provides selection and distribution unit functionality with respect to messages received from Access Terminals (ATs) serviced by the BSC and further provides transcoding functionality in functional block 118 with respect to transcoding between the vocoder formats provided by the ATs and the vocoder formats provided by networks coupled to network 110, such as a 64 kbps PCM format (ITU-T G.711). However, in other embodiments of the present invention, the transcoding functionality may reside in MSC 120 instead of BSC 116. MGW 122 provides a gateway for circuit services network 110 to far end network 170, for example, an external data network such as an Internet Protocol (IP) network such as the Internet. When AT 102 is engaged in a voice call with an other end point (OEP) 172 via circuit services network 110 and far end network 170, MGW 122 converts Pulse Code Modulation (PCM) signals received from MSC 120 to data packets, for example, based on a Real Time Protocol/User Datagram Protocol/Internet Protocol (RTP/UDP/IP) protocol suite, for routing to external data network 170 and converts voice data received from data network 170 to a PCM over TDM (Time Division Multiplex) format for routing to MSC 120.

Packet data network 130 comprises a packet data node 134 coupled to a Packet Data Serving Node (PDSN) 138, or when packet data network 130 is a WLAN network to a Packet Data Interworking Function (PDIF), via a bearer (A10) interface and a signaling (A11) interface. PDSN 138 further has a signaling control path connection with a Proxy-Call Session Control Function (P-CSCF) 140 and is connected to far end network 170 via an interface supporting the RTP/UDP/IP protocol suite for an exchange of packet data when engaged in a packet data session with the OEP 172. Packet data node 134 provides wireless packet data communication services to ATs located in a coverage area of the packet data node. Packet data node 134 comprises a wireless Access Network (AN) (not shown), such as a BTS coupled to a BSC, an Access Point (AP), or a Node B coupled to a Radio Network Controller (RNC). Packet data node 134 may further comprise a Packet Control Function (PCF) (not shown) that may be coupled to the AN via one or more of a bearer connection and a signaling connection, such as an A8 and an A9 interface. When packet data node 134 comprises an AN and a PCF, the functionality described herein as being performed by packet data node 134 may be performed by either the AN or the PCF or may be distributed among the AN and the PCF.

Each of BS 112 and packet data node 134 provides wireless communication services to Access Terminals (ATs) located in a coverage area of the BS or packet data node via a respective 1X air interface 104 and HRPD air interface 132. Each air interface 104, 132 includes a forward link that includes a pilot channel, at least one forward link traffic channel, and forward link common and dedicated signaling channels. Each air interface 104, 132 further includes a reverse link that includes at least one reverse link traffic channel, reverse link common and dedicated signaling channels, and an access channel.

Circuit services network 110 and packet data network 130, and more particularly BS 112 and packet data node 134, communicate with each other via an Interworking Solution function (IWS) 126. IWS 126 provides an interworking function between packet data network 130 and circuit services network 110 via an A21 inter-RAN interface and supports A21 signaling with the circuit services network. An inter-RAN interface is described in detail in U.S. patent application Ser. No. 11/141,926, attorney docket number CE13247R, which patent application is commonly owned and incorporated herein by reference in its entirety. Further, an A21 inter-RAN interface and an IWS are described in the 3GPP2 A.S0008-B v0.2 and A.S0009-B v0.2 standards. IWS 126 interfaces to packet data network 130 and supports packet data, and in particular HRPD, signaling. IWS 126 provides an interworking function allowing packet data network 130 to convey HRPD air interface signaling to an AT in the circuit services network, thereby permitting an HRPD message to be transported over circuit services network 110 to the AT 102.

In one embodiment of the present invention, IWS 126 may be collocated at BS 112, and further may be located in either BTS 114 or BSC 116, and may be connected to packet data node 134 via an inter-RAN interface, that is, an interface terminating at BS 112 in circuit services network 110 and at packet data node 134 in the packet data network 130, preferably an A21 interface. In another embodiment of the present invention, IWS 126 may collocated at packet data node 134, and further may be located in either the AN or the PCF when the packet data node comprises an AN and/or a PCF, and may be connected to MSC 120 via an A1/A1p interface, and via the MSC to BS 112. When IWS 126 is collocated at packet data node 134, the A21 interface is internal to the packet data node. In yet another embodiment of the present invention, IWS 126 may be a standalone IWS that may be accessed by packet data node 134, for example, via an A21 interface, and by MSC 120, for example, via an A1/A1p interface. The A21 interface is used to transparently pass 1X air interface signaling messages between packet data node 134, and in particular a PCF or an AN of the packet data node 134 when the packet data node 134 includes a PCF and/or an AN, and IWS 126 or, when the IWS is collocated at BS 112, between packet data node 134 and the BS 112. In communication system 100 and unlike in the prior art, the A21 interface is further used to pass HRPD air interface signaling from packet data node 134, and in particular a PCF or an AN of the packet data node 134 when the packet data node 134 includes a PCF and/or an AN, to circuit services network 110.

Each of circuit services network 110 and packet data network 130 communicates with an IP Multimedia Core Network Subsystem (IMS) of home network 150. The IMS comprises an Interrogating Call Session Control Function (I-CSCF) and a Serving Call Session Control Function (S-CSCF), hereinafter collectively referred to as I/S-CSCF 154, that are each coupled to a Home Subscriber Server (HSS) 152 via a signaling (Cx) interface. The IMS of home network 150 further comprises a Voice Call Continuity Application Server (VCC AS) 156, that is coupled to HSS 152 via a signaling (Sh) interface and to I/S-CSCF 154 via a signaling interface capable of supporting Session Initiation Protocol (SIP). Similarly, Although FIG. 1 depicts I-CSCF and S-CSCF as being implemented in a single network element, such as a single server, those who are of ordinary skill in the art realize that I-CSCF and S-CSCF may be implemented in separate network elements without departing from the spirit and scope of the present invention. VCC AS 156, and MSC 120 as well, are each further coupled to a Home Location Register (HLR) 162 via a signaling interface that supports an inter-system protocol, such as Mobile Application Part (MAP). Although single interfaces have been described herein between many of the network elements of communication system 100, each interconnection among elements may comprise multiple interconnections and/or interfaces, such as one or more of a signaling interface, for example, an interface for an exchange of SIP, ISUP, MAP, or Megaco messages, and a bearer interface or path, such as a path for an exchange of voice information.

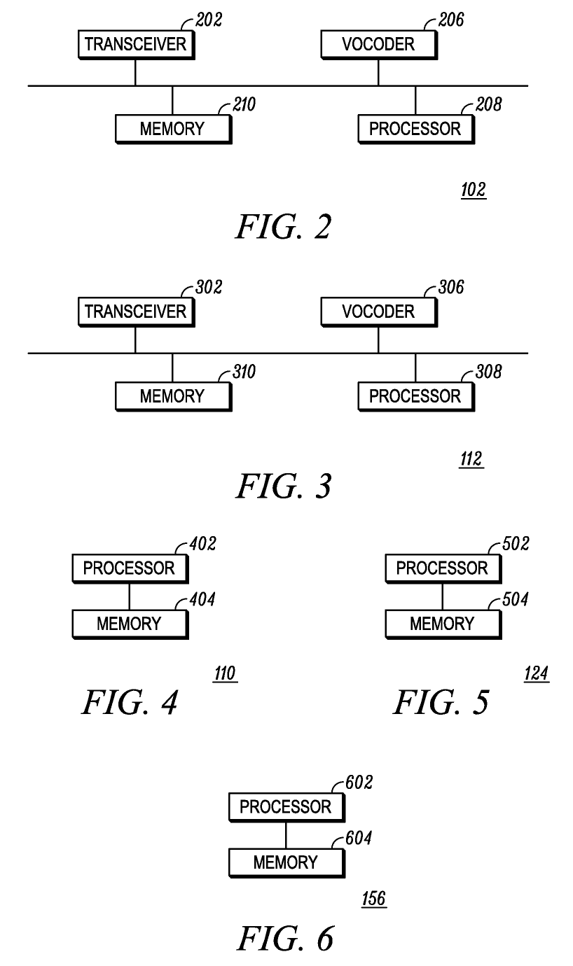

Referring to FIG. 2, a block diagram illustrates an architecture of the AT 102, in accordance with some embodiments of the present invention. AT 102 may include at least one transceiver 202 that allows the AT 102 to transmit or receive in each of the two networks 110 and 130. Transceiver 202 is coupled to a vocoder 206 and a processor 208, which processor 208 is further coupled to an at least one memory device 210. AT 102 may maintain apriori information in at least one memory device 210 that facilitates the switching between networks 110 and 130. Processor 208 may comprise one or more microprocessors, microcontrollers, digital signal processors (DSPs), combinations thereof or such other devices known to those having ordinary skill in the art, which are configured to execute the functions described herein as being executed by AT 102. The at least one memory device 210 may comprise random access memory (RAM), dynamic random access memory (DRAM), and/or read only memory (ROM) or equivalents thereof, that store data and programs that may be executed by the associated processor and that allow AT 102 to perform all functions necessary to operate in communication system 100. When AT 102 has a dormant packet data session being maintained by packet data network 130, the at least one memory device 210 may further maintain Radio Link Protocol (RLP) information associated with the packet data session, such as an identification of an HRPD RLP flow to which packet data is to be sent, for example, an ‘HRPD RLPFlowID.’

Referring to FIG. 3, a block diagram illustrates an architecture of the BS 112, in accordance with some embodiments of the present invention. BS 112 includes a respective processor 308, such as one or more microprocessors, microcontrollers, digital signal processors (DSPs), combinations thereof or such other devices known to those having ordinary skill in the art, which processor 308 is configured to execute the functions described herein as respectively being executed by the BS 112. BS 112 may include at least one transceiver 302 that allows the BS 112 to transmit or receive signals from the AT 102. Transceiver 302 is coupled to a vocoder 306, to the processor 308, and to an at least one memory device 310. The at least one memory device 310 may comprise random access memory (RAM), dynamic random access memory (DRAM), and/or read only memory (ROM) or equivalents thereof, that store data and programs that may be executed by the associated processor 308 and that allow the BS 112 to perform all functions necessary to operate in the communication system 100.

Referring to FIG. 4, a block diagram illustrates an architecture of the MSC 110, in accordance with some embodiments of the present invention. The MSC 110 includes a respective processor 402, such as one or more microprocessors, microcontrollers, digital signal processors (DSPs), combinations thereof or such other devices known to those having ordinary skill in the art, which processor 402 is configured to execute the functions described herein as respectively being executed by the MSC 110. The MSC 110 further includes a respective at least one memory device 404 that may comprise random access memory (RAM), dynamic random access memory (DRAM), and/or read only memory (ROM) or equivalents thereof, that store data and programs that may be executed by the associated processor 402 and that allow the MSC 110 to perform all functions necessary to operate in the communication system 100.

Referring to FIG. 5, a block diagram illustrates an architecture of the MGCF 124, in accordance with some embodiments of the present invention. The MGCF 124 includes a respective processor 502, such as one or more microprocessors, microcontrollers, digital signal processors (DSPs), combinations thereof or such other devices known to those having ordinary skill in the art, which processor 502 is configured to execute the functions described herein as respectively being executed by the MGCF 124. The MGCF 124 further includes a respective at least one memory device 504 that may comprise random access memory (RAM), dynamic random access memory (DRAM), and/or read only memory (ROM) or equivalents thereof, that store data and programs that may be executed by the associated processor 502 and that allow the MGCF 124 to perform all functions necessary to operate in the communication system 100.

Referring now to FIG. 6, a block diagram illustrates an architecture of the VCC AS 156, in accordance with some embodiments of the present invention. The VCC AS 156 includes a respective processor 602, such as one or more microprocessors, microcontrollers, digital signal processors (DSPs), combinations thereof or such other devices known to those having ordinary skill in the art, which processor 602 is configured to execute the functions described herein as respectively being executed by the VCC AS 156. The VCC AS 156 further includes a respective at least one memory device 604 that may comprise random access memory (RAM), dynamic random access memory (DRAM), and/or read only memory (ROM) or equivalents thereof, that store data and programs that may be executed by the associated processor 602 and that allow the VCC AS 156 to perform all functions necessary to operate in the communication system 100.

The functionality described herein as being performed by AT 102, BS 112, MSC 110, MGCF 124 and VCC AS 156 is implemented with or in software programs and instructions stored in the respective at least one memory device 210, 310, 404, 504 and 604 and executed by the associated processor 208, 308, 402, 502 and 602 of the AT 102, BS 112, MSC 110, MGCF 124 and VCC AS 156. When BS 112 comprises BTS 114 and a BSC 116, the functions described herein as being performed by the BS 112 may be performed by a processor included in BTS 114 or a processor included in BSC 116 or may be distributed among the processors of BTS 114 and BSC 116 based on data and programs respectively stored in a corresponding at least one memory device of BTS 114 and BSC 116. However, one of ordinary skill in the art realizes that the embodiments of the present invention alternatively may be implemented in hardware, for example, integrated circuits (ICs), application specific integrated circuits (ASICs), and the like, such as ASICs implemented in one or more of AT 104, BS 112, and packet data node 134. Based on the present disclosure, one skilled in the art will be readily capable of producing and implementing such software and/or hardware without undo experimentation.

In order for AT 102 to engage in a circuit voice call or a packet data call respectively via circuit services network 110 or packet data network 130, each of AT 102, circuit services network 110, and packet data network 130 operates in accordance with well-known wireless telecommunications protocols. For example, circuit services network 110 can be a cdma2000 (code division multiple access) communication system that provides circuit switched communication services to subscribers serviced by the network (it may also provide packet data services) and that operates in accordance with the 3GPP2 C.S0001 to C.S0005 standards, which provides an air interface compatibility standard for CDMA 1X systems. Packet data network 130 can be a cdma2000 communication system that provides HRPD communication services to subscribers serviced by the network 130 and that operates in accordance with the 3GPP2 (Third Generation Partnership Project 2) C.S0024-A standard, which provides an air interface compatibility standard for cdma2000 HRPD (High Rate Packet Data) systems and the 3GPP2 C.S0075 standard, which provides HRPD-1X inter-technology air interface support. The IP Multimedia Core Network Subsystem (IMS) of home network 150 operates in accordance with the 3GPP2 X.S0013 standards, which describe the operation, elements, and interfaces of an IMS.

Further, circuit services network 110 and AT 102 can operate in accordance with the 3GPP2 A.S0011-A.S0017 Inter Operability Specifications (IOS) standards, which provide a compatibility standard for cellular mobile telecommunications systems that operate as a cdma2000 1X system. In addition, packet data network 130 and again AT 102 can operate in accordance with one or more of the 3GPP2 A.S0008-B v0.2 or A.S0009-B v0.2 (v&v versions) HRPD IOS standards, which provide compatibility standards for cellular mobile telecommunications systems that operate as a cdma2000 HRPD system. To ensure compatibility, radio system parameters and call processing procedures are specified by the standards, including call processing steps that are executed by an AT and a base station or other access network serving the AT and between the base station or other access network and associated infrastructure. However, those of ordinary skill in the art realize that packet data network 130 may operate in accordance with any one of a variety of wireless packet data communication systems that provide high rate packet data communication services, such as systems conforming to the IEEE (Institute of Electrical and Electronics Engineers) 802.xx standards, for example, the 802.11, 802.15, or 802.16 or 802.20 standards, and that circuit services network 110 may operate in accordance with any one of a variety of well-known conventional wireless telecommunication systems that provide circuit switched communication services.

In order to access circuit services network 110, AT 102 tunes to an operating frequency assigned to the circuit services network 110, acquires a pilot channel associated with a serving BS, such as BS 112, and then registers with MSC 120 via BS 112 and a reverse link access channel of air interface 104. Once AT 102 is registered, the AT may monitor a forward link paging channel of air interface 104. The paging channel may then be used to notify AT 102 when a voice call arrives via circuit services network 110. Alternatively, AT 102 may originate a circuit voice call after acquiring the pilot channel associated with BS 112 by requesting circuit voice service on a 3G1X reverse link access channel. The paging channel is further used when packet data network 130 has received packet data from home network 150 and requests circuit services network 110 to page AT 102 to request the AT 102 to move to the packet data network 130 so that the packet data can be delivered to the AT 102.

When AT 102 is not engaged in a voice call with, or monitoring a paging channel in, circuit services network 110, the AT 102 may initiate a packet data call and register with packet data network 130, and more particularly with home network 150. AT 102 may then establish a data link with PDSN 138 in accordance with a Layer 2 protocol such as a Point-to-Point Protocol (PPP). The Point-to-Point Protocol may then be used to assign an IP address to AT 102. Once the IP address is assigned and a packet data session is established, AT 102 may communicate with packet data network 130 over a packet data network connection. The packet data network connection, comprising packet data node 134 and an AN and a PCF servicing AT 102 in network 130, is communicated by the packet data network 130 to MSC 120 and is stored by the MSC 120.

The C.S0024 standard provides for the packet data network packet data session to remain intact whether or not the connection is being used to support communications. That is, when AT 102 accesses packet data network 130 to establish a packet data session, the AT 102 is assigned a traffic channel in air interface 132 and packet data are transferred to the AT 102 via the traffic channel and the packet data network connection. During subsequent periods of inactivity in packet data network 130, for example, when AT 102 is active in a voice call in circuit services network 110, the traffic channel may be torn down but the packet data session remains intact. By maintaining the packet data session, AT 102 does not have to acquire a new IP address or establish a new PPP connection for a subsequent exchange of data. A packet data session that exists in the absence of a traffic channel is referred to as a “dormant” session.

In communication system 100, when AT 102 is engaged in a circuit voice call in circuit services network 110, the AT 102 may roam through the communication system 100. As a result of the roaming, situations may arise where it is desirable to hand off AT 102 from circuit services network 110 to packet data network 130. For example, as is known in the art, while roaming in communication system 100 and being serviced by BS 112, AT 102 may receive a stronger signal from packet data node 134. Typically signal strengths are determined by an AT, such as AT 102, measuring a pilot channel associated with the packet data node or BS. When a pilot channel of a serving packet data node or BS is weaker than a threshold value and a pilot channel of another packet data node or BS, that typically indicates a desirability of a handoff.

By way of another example, it may be desirable to move an AT, such as AT 102, that is actively engaged in a multimedia call in packet data network 130 to circuit services network 110 when the user of AT 102 prefers to use a circuit switched network for a voice call rather than a service in a packet data network.

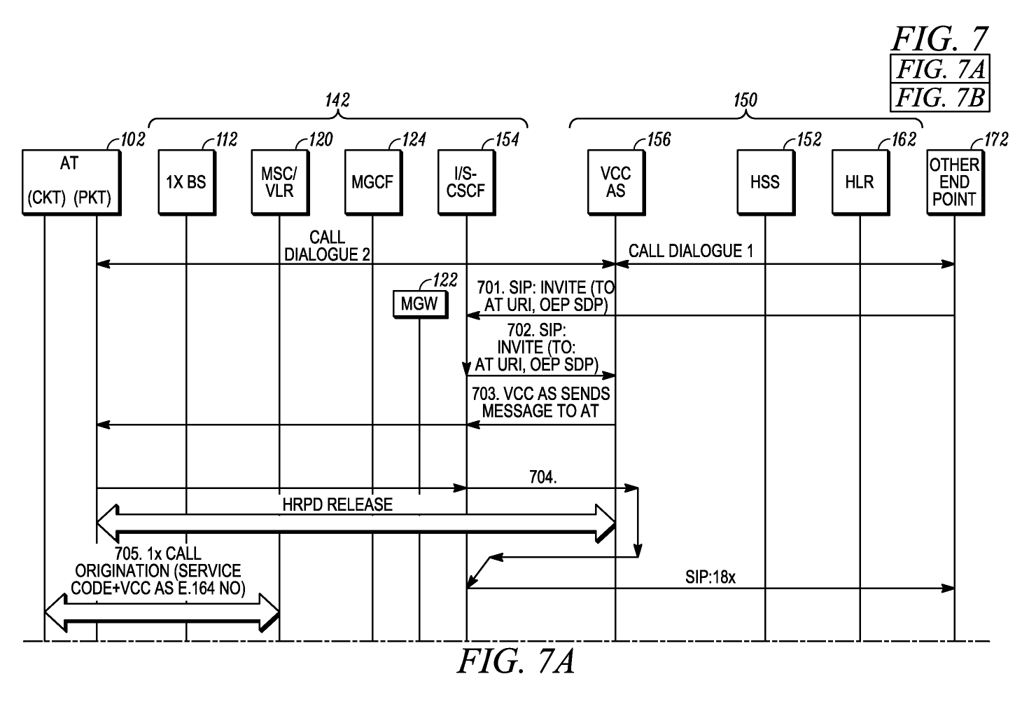

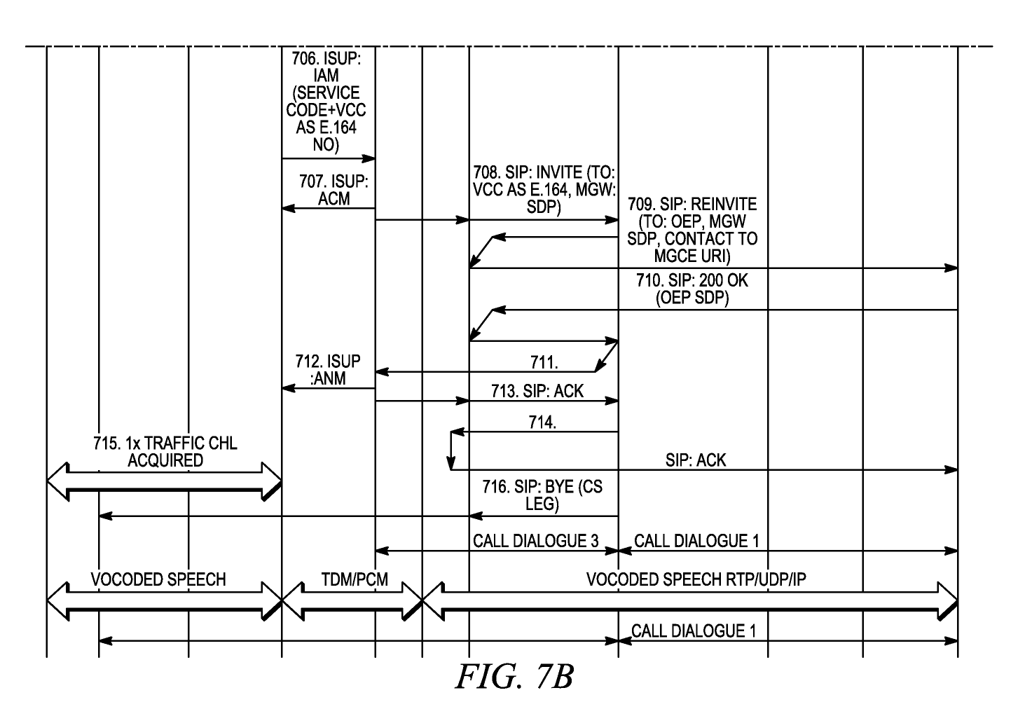

Referring to FIGS. 7A and 7 B, message sequence charts illustrate a method for establishing a circuit switched (CS) call at the AT 102 that is processing an established packet switched (PS) call through the packet data network 130, according to some embodiments of the present invention. A packet switched call refers to any of various types of voice or data services provided through a packet data network. As shown at the top of FIG. 1, consider that the VCC AS 156 in the home network 150 is processing an SIP call dialogue 1 with the OEP 172 and an SIP call dialogue 2 with the AT 102.

At step 701, the OEP 172 transmits a session initiation protocol (SIP) INVITE message, including a uniform resource identifier (URI) of the AT 102, and session description protocol (SDP) information concerning a requested voice call, to the I/S-CSCF 154 in the visited network 142. At step 702, based upon initial filter criteria (iFC), the I/S-CSCF 154 forwards the SIP INVITE message to the VCC AS 156 in the home network 150. Based on the SIP INVITE message, the VCC AS 156 determines that the request for the voice call needs to be delivered to an HRPD system. At step 703, the VCC AS 156 therefore forwards the SIP INVITE message to the AT 102 through the I/S-CSCF 154. Following step 703, a user of the AT 102 can determine whether or not to accept the voice call from the OEP 172. As will be understood by those skilled in the art, conventional call waiting features, such as audible tones, messages, or visual displays, can be used to inform a user of the AT 102 of the voice call. If the user decides to accept the voice call, then at step 704 the AT 102 transmits an SIP 18x message to the OEP 172 through the I/S-CSCF 154 and the VCC AS 156. The AT 102 also initiates a release of an HRPD air link associated with the VT call.

At step 705, the AT 102 tunes to its 1x mode and initiates a call origination, such as an Origination in an air interface and A1 CM service request message in an A1/A1p interface, through the BS 112, to the MSC 120. Alternatively, the AT 102 can originate a 1x call via an HRPD air interface by using a Circuit Services Notification Application, as will be understood by those skilled in the art. However, where the call origination message is transmitted to the MSC 120, then at step 706 the MSC 120 performs a translation on a called party American standard code for information interchange (ASCII) number field in the A1 CM service request message. Using a service code value of the called party ASCII number field, the translation performed by the MSC 120 results in an international digital subscriber network (ISDN) user part (ISUP) initial address message (IAM) being routed from the MSC 120 to the MGCF 124 in the visited network 142. The MSC 120 forms the ISUP IAM message by using a VCC AS E.164 number for the called party number field and the E.164 number of the AT 102 for the calling party number field. In the ISUP IAM the MSC 120 strips away the service code value of the called party ASCII field.

At step 707, after receiving the ISUP IAM message, the MGCF 124 returns an address complete message (ACM) to the MSC 120. The MGCF 124 also requests the MGW 122 to create two terminations as follows: A first termination is a time division multiplexed (TDM) connection between the MGW 122 and the MSC 120. A second termination is a real time transport protocol/user datagram protocol/internet protocol (RTP/UDP/IP) ephemeral termination.

At step 708, the MGCF 124 determines a VCC AS SIP URI via, for example, an E.164 number mapping request (ENUM) query, and sends an SIP INVITE message via the I/S-CSCF 154 to the VCC AS 156, including an SDP offer with the SDP information of the MGW 122. At step 709, the VCC AS 156 transmits an SIP re-INVITE message to the I/S-CSCF 154 including the SDP offer with the SDP information of the MGW 122. The VCC AS 156 examines a “from” header of the SIP INVITE message, which was received at step 708, to determine an identity of the AT 102. Note that the VCC AS 156 has already been placed in the 1x call flow signaling path during session setup. The I/S-CSCF 154 then forwards the re-INVITE message to the OEP 172.

At step 710, the OEP145, using its MGCF/MGW, modifies its RTP bearer termination with the SDP information of the MGW 122 and sends an SIP 200 OK message to the I/S-CSCF 154. The SIP 200 OK message includes an SDP answer with the SDP information of the OEP 172 in response to the SIP re-INVITE message that it received from the I/S-CSCF 154 at step 709. The I/S-CSCF 154 then forwards the SIP 200 OK message to the VCC AS 156. At step 711, the VCC AS 156 forwards an SIP 200 OK message via the I/S-CSCF 154 to the MGCF 124, where the SIP 200 OK message includes an SDP answer with the SDP information of the OEP 172, in response to the SIP INVITE message that the VCC AS 156 received from the MGCF 124 at step 708.

At step 712, the MGCF 124 requests modification of the ephemeral termination of the MGW 122 with the SDP information of the OEP 172, and instructs the MGW 122 to reserve or commit remote resources as appropriate. The MGCF 124 then sends an ISUP answer message (ANM) to the MSC 120. At step 713, which can occur anytime after step 710, the MGCF 124 sends an SIP acknowledgement (ACK) message to the VCC AS 156 in response to the SIP 200 OK message that it received from the VCC AS at step 710. That completes establishment of an SIP call dialogue 3 between the MGCF 124 and the VCC AS 156. The VCC AS 156 stores the location of the AT 102 as present in the visited network 142 and sends an SIP ACK message to the I/S-CSCF 154 in response to the SIP 200 OK message that it received from the I/S-CSCF 154 at step 710, and the I/S-CSCF 154 forwards the SIP ACK message to a MGCF at the OEP 172. At step 715, which occurs anytime after step 710, the BS 112 acquires a 1x traffic channel of the AT 102.

At step 716, which occurs anytime after step 710, the VCC AS 156 transmits via the I/S-CSCF 154 an SIP release (BYE) message to the AT 102, which releases the SIP call dialog 2 between the AT 102 and the VCC AS 156. However, because the AT 102 is already tuned to the 1x traffic channel, the AT 102 does not respond to the SIP BYE message. The voice call is then established in the circuit services network 110.

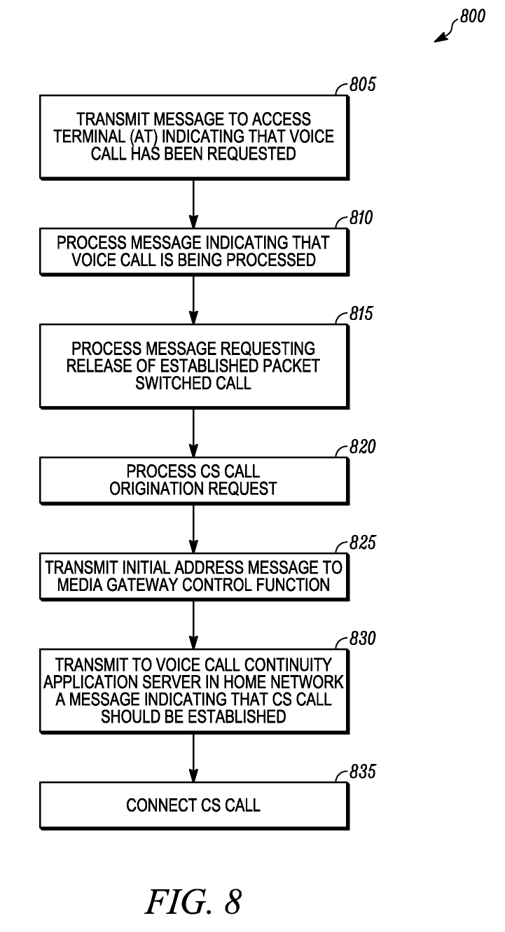

Referring to FIG. 8, a general flow diagram illustrates a method 800 for establishing a circuit switched (CS) call at an access terminal that is processing an established packet switched (PS) call, according to some embodiments of the present invention. At step 805, a packet switched message indicating that a voice call has been requested, is transmitted from a visited network to the access terminal. For example, at step 703 in FIG. 7, the I/S-CSCF 154 forwards an SIP INVITE message to the AT 102.

At step 810, a message from the access terminal, indicating that the voice call is being processed, is processed in the visited network. For example, at step 704 in FIG. 7, the AT 102 transmits an SIP 18x message to the OEP 172 through the I/S-CSCF 154.

At step 815, a message from the access terminal, requesting release of the established packet switched call, is processed in the visited network, and a message from the access terminal is processed in the home network indicating that the voice call is being processed. For example, referring again to FIG. 7, if the user decides to accept the voice call then at step 704 the AT 102 transmits an SIP 18x message to the OEP 172 through the I/S-CSCF 154 and the VCC AS 156. The AT 102 also initiates a release of an HRPD air link associated with the VT call.

At step 820, a message from the access terminal, requesting a circuit switched call origination, is processed at a mobile switching center in the visited network. For example, at step 705 in FIG. 7, the AT 102 tunes to its 1x mode and transmits a call origination message, through the BS 112, to the MSC 120. Alternatively, the AT 102 can use an HRPD Circuit Services Notification Application to transmit a call Origination message, through the packet data node 134, to the MSC 120.

At step 825, in response to the message from the access terminal requesting a circuit switched call origination, an initial address message is transmitted from the mobile switching center to a media gateway control function in the visited network. For example, at step 706 in FIG. 7, the MSC 120 performs a translation on a called party American standard code for information interchange (ASCII) number field in the A1 CM service request message and, using a service code value of the called party ASCII number field, the translation performed by the MSC 120 results in an international digital subscriber network (ISDN) user part (ISUP) initial address message (IAM) being routed from the MSC 120 to the MGCF 124 in the visited network 142.

At step 830, in response to the circuit switched call origination message, a message indicating that the circuit switched call should be established is transmitted from the visited network to a voice call continuity application server in a home network. For example, at step 708 in FIG. 7, the MGCF 124 determines a VCC AS SIP URI via, for example, an E.164 number mapping request (ENUM) query, and sends an SIP INVITE message via the I/S-CSCF 154 to the VCC AS 156, including an SDP offer with the SDP information of the MGW 122. Finally, at step 835, the circuit switched call is connected.

Advantages of embodiments of the present invention thus include enabling an access terminal that has dual mode capabilities, such as a dual mode cellular telephone or other wireless communication device, that is operating in a packet switched mode and processing an established packet switched call, to receive a message indicating that a voice call to the access terminal has been requested. A user is able to either accept or reject the requested voice call. If the voice call is accepted, the packet switched call is released and a circuit switched call is established.

The above detailed description provides an exemplary embodiment only, and is not intended to limit the scope, applicability, or configuration of the present invention. Rather, the detailed description of the exemplary embodiment provides those skilled in the art with an enabling description for implementing the exemplary embodiment of the invention. It should be understood that various changes can be made in the function and arrangement of elements and steps without departing from the spirit and scope of the invention as set forth in the appended claims. It will be appreciated that embodiments of the invention described herein may be comprised of one or more conventional processors and unique stored program instructions that control the one or more processors to implement, in conjunction with certain non-processor circuits, some, most, or all of the functions of establishing a circuit switched call at an access terminal that is processing an established packet switched call as described herein. The non-processor circuits may include, but are not limited to, a radio receiver, a radio transmitter, signal drivers, clock circuits, power source circuits, and user input devices. As such, these functions may be interpreted as steps of a method for establishing a circuit switched call at an access terminal that is processing an established packet switched call. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method for establishing a circuit switched call at an access terminal that is processing an established packet switched call, the method comprising:
transmitting, from a visited network to the access terminal, a packet switched message indicating that a voice call has been requested;
processing in the visited network a message from the access terminal indicating that the voice call is being processed;
processing at a mobile switching center in the visited network a message from the access terminal requesting a circuit switched call origination;
transmitting from the visited network to a voice call continuity application server in a home network, in response to the message from the access terminal requesting a circuit switched call origination, a message indicating that a circuit switched call should be established; and
connecting the circuit switched call.

2. The method of claim 1, further comprising processing in the home network a message from the access terminal indicating that the voice call is being processed.

3. The method of claim 1, wherein the message from the access terminal requesting a circuit switched call origination comprises a service code and a voice call continuity application server E.164 number.

4. The method of claim 1, wherein the message from the access terminal requesting a circuit switched call origination is transmitted to a circuit switched base station and then forwarded to the mobile switching center.

5. The method of claim 1, wherein the message from the access terminal requesting a circuit switched call origination employs a high rate packet data circuit services notification protocol.

6. The method of claim 1, further comprising transmitting, in response to the message from the access terminal requesting a circuit switched call origination, from the mobile switching center to a media gateway control function in the visited network, an initial address message.

7. The method of claim 6, wherein the initial address message comprises a voice call continuity application server E.164 number and a service code in a called party number field.

8. The method of claim 6, wherein the initial address message comprises an E.164 number of the access terminal in a calling party number field.

9. The method of claim 1, wherein transmitting from the visited network to the voice call continuity application server in the home network, in response to the circuit switched call origination message, a message indicating that the circuit switched call should be established, comprises transmitting a session initiation protocol INVITE message from a media gateway control function in the visited network.

10. The method of claim 9, wherein a media gateway control function determines a session initiation protocol uniform resource identifier of the voice call continuity application server using an E.164 number mapping request.

11. The method of claim 1, wherein processing at the mobile switching center the message from the access terminal requesting the circuit switched call origination, comprises translating a called party American standard code for information interchange number field.

12. The method of claim 1, wherein the method conforms to a Third Generation Partnership Project 2 standard.
